(19) United States
(12) Patent Application Publication
(10) Pub. No.: US 2007/0067440 A1
(43) Pub. Date: Mar. 22, 2007

(54) Application splitting for network edge computing

(76) Inventors: Kulvir S. Bhogal, Fort Worth, TX (US); Alexandre Polozoff, Bloomington, IL (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/232,744

(22) Filed: Sep. 22, 2005

(51) Int. Cl. G06F 15/173

(52) U.S. Cl. 709/224

(57) ABSTRACT

Methods, apparatus, and computer program products are provided for application splitting for network edge computing. Embodiments include gathering resource utilization data for an enterprise network. Gathering resource utilization data for an enterprise network may include, for example, monitoring utilization of network resources of the enterprise network using a network management system. Embodiments also include determining whether resource utilization data meets an application split threshold. If the resource utilization data meets an application split threshold, an application on the enterprise network to split may be identified. Identifying an application on the enterprise network to split may include, for example, gathering application data of the enterprise network, and identifying an application to split based on the application data. The application is split into a plurality of subcomponents, and at least one subcomponent of the application is moved to an edge network.

### BACKGROUND OF THE INVENTION

1. Field of the Invention

The field of the invention is data processing, or, more specifically, methods, apparatus, and products for application splitting for network edge computing.

2. Description of Related Art

The Internet and the World Wide Web operate primarily in a client-server model for data communications. The content being transferred is increasingly complex, and clients are increasingly diverse. It is becoming more and more difficult to efficiently deliver complex, varied content to increasingly diverse client devices. The increased demand results in more and more new devices, new servers, and new clients to handle each new type of data.

In the conceptual client-server model, the client requests information from the server and the server sends information back in the format requested by the client. This content delivery system was once considered ideal since one need only concentrate on processing at the “ends.” However, reality has demanded more, and in response new services have emerged. Caches near the client and on edge-delivery points make operations faster and lighten the network load. Gateways (such as those for wireless devices) help diverse groups of clients connect. Content Delivery Networks (CDNs) better organize the vast array of Internet content for the client. All these services have grown independently of one another, however, making extensions and new services vendor-specific and hard to manage. With the evolution of diverse client devices, content providers are forced to offer data in every necessary format for every device, personal data assistants (PDAs), personal computers (PCs), cell phones, laptop computers, e-book readers, and others. Servers are forced to handle differences between the formats available and the formats the client can accept.

The network edge architecture provides a means to address the complexities that have grown for “in the network” services. The term “network edge” is usually used to describe a physical or network boundary of an entity in the Internet. For example, network edges could be the set of access points of an Internet Service Provider (“ISP”) or the intranet of an enterprise network. “Network edge” can also mean a distinguished point of content delivery, such as the boundary of a country, a point at which it is useful to translate data into an appropriate language or format. The network edge is the point where content processing can occur in the path of content delivery.

The network edge architecture is a collection of technologies for performing part of the content delivery processes for transferring data between clients and servers. Network edge architecture is a unified approach to developing software and hardware for performing content delivery functions. Network edge architecture allows for operations such as data transcoding. Content providers can offer data in a single, standard format regardless of the type of client device, and network edge architecture makes it easier to provide a format for the presentation suited to the device. For example, a content provider may store content in a single format, regardless of the type of client device that may request the content, and the network edge technology may reformat the content for the receiving device. A rule-based service running on an edge server or an edge network makes the appropriate data transformations based on standardized protocols for various devices.

Consider an example of a movie delivery. With network edge technology, consumers see the movie in the format appropriate to consumers devices and their personal tastes. The content provider no longer has to worry about the device on which the movie will be viewed, because the burden of data transformation is removed from content providers and servers. Instead, data transformation is consolidated at the network edge.

In the traditional client/server architecture, customer information and client device interfaces must be managed on the client device or on the content server. That is, the customer is required to re-enter data, and the server is required to cope with client diversity issues, whether the client device is a cell phone, a PDA, a laptop, a personal computer, and so on.

The transfer and reformulation of content from provider to client happens in several steps. A client's request is amended, that is, personalized, in accordance with known information retained in the server with additional needed data being entered from the client. For example, the client may be using a cell phone to access the World Wide Web or an email service. This requires that the server send back only content appropriate to that cell phone interface and progress through voice menus or keyboard menus to obtain customer specifics. In the network edge architecture, an edge server amends the client's request to specify the appropriate cell phone interface. Then the edge server communicates with content servers to fill in customer data, thereby simplifying customer interaction. Then the edge server amends the request to the content servers to obtain data that is then reformulated by the edge server to fit the client's device. The appropriate content is then downloaded to the client device in a manner suitable for the client device.

The network edge server resides between the client and the content servers and serves as an agent for both the customer and the content provider. When the client sends out a request for content, a network edge server amends the request, typically based on a set of predefined rules, according to the customer's information. The edge server then sends the amended request on to the content server, possibly with some exchange to the content server as indicated previously. The content server is relieved of the burden of amending the request or reformulating the content. Any transformation of content that is needed will happen at the network edge server using standard protocols. In this way, network edge architecture simplifies the information required from the content provider to address different formats needed for different devices.

Network edge architecture represents a growing shift from the traditional client-server model to a more efficient client-edge-server model. When content-level services are performed at the network edge, content providers can offer personalized, scalable services. With network edge architecture, the edge plays a role that is currently forced on both client and server. Application software that was installed entirely on a content server or an application server in the traditional client-server architecture now may be deployed to an edge network. In addition, application software that was installed entirely on a content server or an application server in the traditional client-server architecture now may be split, and in many cases, must be split, between the content server and the edge, thereby freeing up capacity on the content server. It would be useful to have automated tools to identify when an enterprise network would benefit from deploying some application components to an edge network. It would also be useful to have automated tools to identify which application or applications to split between the enterprise network and the edge network. Once an application to split has been identified, it would be useful to have automated tools to determine how an application should be prepared for deployment to the edge and how to split the application.

### SUMMARY OF THE INVENTION

Methods, apparatus, and computer program products are provided for application splitting for network edge computing. Embodiments include gathering resource utilization data for an enterprise network. Gathering resource utilization data for an enterprise network may include, for example, monitoring utilization of network resources of the enterprise network using a network management system. Embodiments also include determining whether resource utilization data meets an application split threshold. If the resource utilization data meets an application split threshold, an application on the enterprise network to split may be identified. Identifying an application on the enterprise network to split may include, for example, gathering application data of the enterprise network, and identifying an application to split based on the application data. The application is split into a plurality of subcomponents, and at least one subcomponent of the application is moved to an edge network.

In some embodiments, splitting the application includes identifying an application split point, identifying a split type for the application split point, and splitting the application into subcomponents in accordance with the split type. In some embodiments, splitting the application includes gathering application data of the enterprise network, identifying an application split point, identifying a split type for the application split point, determining, in dependence upon the application data, one or more preferred split types, and splitting the application into subcomponents in accordance with the one or more preferred split types.

Some embodiments also include providing resources to the edge network that are needed by the edge network to execute the application subcomponent moved to the edge network. For example, the resources needed by the edge network to execute the application subcomponent moved to the edge network may include configuration information for URI mapping.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for application splitting for network edge computing according to some or exemplary embodiments of the present invention.

FIG. 2 sets forth a block diagram of automated computing machinery useful in application splitting for network edge computing according to some or exemplary embodiments of the present invention.

FIG. 3 sets forth a block diagram illustrating an exemplary system for application splitting for network edge computing according to some or exemplary embodiments of the present invention.

FIG. 4 sets forth a block diagram illustrating an exemplary system that operates generally to split an application according to some or exemplary embodiments of the present invention.

FIG. 5 sets forth a flowchart illustrating an exemplary method for application splitting for network edge computing according to some or exemplary embodiments of the present invention.

FIG. 6 sets forth a flowchart illustrating an exemplary method for application splitting for network edge computing according to some or exemplary embodiments of the present invention.

FIG. 7 sets forth a flowchart illustrating an exemplary method for identifying an application split point.

FIG. 8 sets forth a flowchart illustrating exemplary methods for identifying a split type for an application split point.

### DETAILED DESCRIPTION OF EXEMPLARY EMBODIMENTS

Introduction

The present invention is described to a large extent in this specification in terms of methods for application splitting for network edge computing. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium as well as any transmission medium such as wireless transmission, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware or combination of hardware and software are well within the scope of the present invention.

Exemplary embodiments of the present invention are described largely in the context of a fully functional computer system for application splitting for network edge computing. Readers with skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware or combination of hardware and software are well within the scope of the present invention.

### DETAILED DESCRIPTION

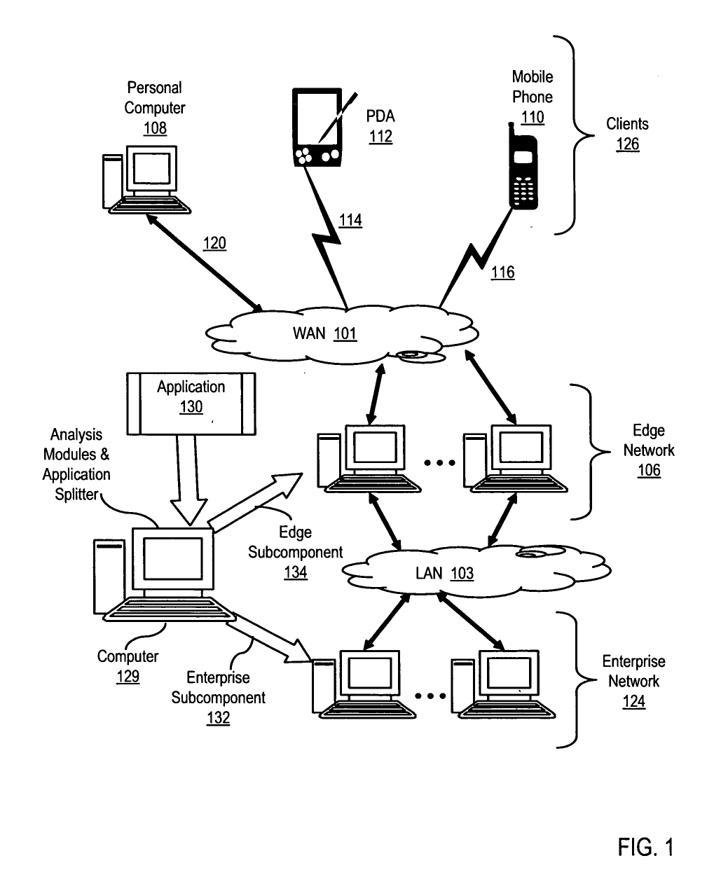

Exemplary methods, apparatus, and products for application splitting for network edge computing according to embodiments of the present invention are described with reference to the accompanying drawings, beginning with FIG. 1. FIG. 1 sets forth a network diagram illustrating an exemplary system for application splitting for network edge computing according to embodiments of the present invention. The system of FIG. 1 includes several exemplary client devices (126) connected through a wide area network (101) to several edge servers configured as an edge network (106). The edge servers are in turn connected through local area network (103) to several applications and content servers represented as enterprise network (124).

The client devices (126) in the example of FIG. 1 include a personal computer (108) connected to wide area network (101) through wire line connection (120), a wireless, network-enabled personal digital assistant (‘PDA’) (112) connected to wide area network (101) through wireless connection (114), and mobile telephone (110) connected to wide area network (101) through wireless connection (116).

The system of FIG. 1 includes an application program (130) available to computer (129) for splitting into two or more modules, including at least one edge subcomponent (134) for installation on the edge network (106) and at least one enterprise subcomponent (132) for installation on the enterprise network (124). Computer (129) is a computer having a software development environment such as the Java™ Software Development Kit (‘SDK’) and also having analysis modules and an application splitter that together operate generally by gathering resource utilization data for an enterprise network (124), determining whether the resource utilization data meets an application split threshold, identifying an application (130) on the enterprise network (124) to split if the resource utilization data meets an application split threshold, splitting the application (130) into a plurality of subcomponents (132, 134), and moving at least one subcomponent (134) of the application (130) to the edge network (106).

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

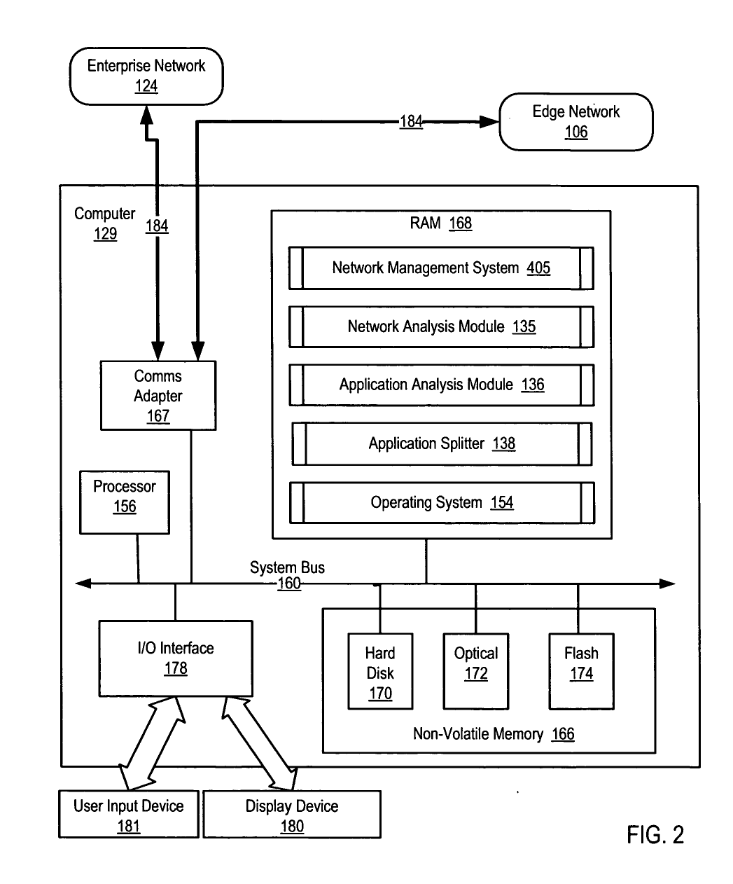

Application splitting for network edge computing in accordance with the present invention is generally implemented with computers, that is, with automated computing machinery. In the system of FIG. 1, for example, all the nodes, servers, and communications devices are implemented to some extent at least as computers. For further explanation, therefore, FIG. 2 sets forth a block diagram of automated computing machinery including an exemplary computer (129) useful in application splitting for network edge computing according to some or exemplary embodiments of the present invention. The computer (129) of FIG. 2 includes at least one computer processor (156) or ‘CPU’ as well as random access memory (168) (‘RAM’) which is connected through a system bus (160) to processor (156) and to other components of the computer.

Stored in RAM (168) is a network management system (405), computer program instructions for monitoring utilization of network resources of an enterprise network. The network management system (405) gathers information about the utilization of resources on the enterprise network (124). One example of a network management system useful in application splitting for network edge computing according to one embodiment of the present invention is the Tivol™ Enterprise Console. The Tivol™ Enterprise Console monitors events on a network and automatically takes certain actions based on the event monitoring. The Tivol™ Enterprise Console accepts events from a variety of applications and devices, and analyzes the events using specific correlation technologies to determine what events are important and to determine an appropriate response. The Tivoli™ Enterprise Console may usefully gather information about the utilization of resources on the enterprise network in accordance with the present invention.

Also stored RAM (168) is a network analysis module (135), computer program instructions for gathering and analyzing resource utilization data to determine when to split an application on the enterprise network. The network analysis module (135) of FIG. 2 is capable of communicating with the network management system (405), requesting from the network management system information about the utilization of resources on the enterprise network (124) and receiving from the network management system information about the utilization of resources on the enterprise system to determine if the application split threshold is met.

Also stored RAM (168) is an application analysis module (136), computer program instructions for gathering and analyzing application data to identify an application to split, to identify application split points, to identify split types for the split points, and to determine preferred split types. The application analysis module gathers application data of the enterprise network, and identifies an application to split based on the application data. Application data is data describing an application and often the current usage of the application, or the interaction of the application with enterprise network resources useful in identifying an application to split. Application data typically includes information about an application itself such as an application ID, the size of the application, the components of an application, resources used by the application, and so on as will occur to those of skill in the art. Application data also typically includes information about usage of the application such as the applications current state, resources currently consumed by the application, percentage of network traffic attributable to the application, and so on as will occur to those of skill in the art. The application analysis module of FIG. 2 identifies an application to split based on one or more factors such as the type application available for splitting, the usage of such an application, the construction of the application, how splitting that application will affect the utilization of network resources, or other factors that will occur to those of skill in the art.

Also stored in RAM (168) is an application splitter module (138), a set of computer program instructions for application splitting for network edge computing according to embodiments of the present invention. The application splitter module (138) generally operates by creating subcomponents of the application (130 in FIG. 1) by splitting the application at the split points identified by the application analysis module (136) in accordance with the preferred split type for each split point.

A split type is a categorization of the manner in which an application is split at a particular split point. Examples of split types include EJB split types, façade split types, silo split types, and others as will occur to those of skill in the art. An EJB split implements a server-side component that encapsulates logic that fulfills a purpose of the application. By invoking methods of the EJB, remote clients can access services provided by the application. For an EJB split type, for example, the application splitter module (138) of FIG. 2 is capable of splitting an application (130 in FIG. 1) into a client RMI™ (“Java Remote Method Invocation”) module and a server RMI module, moving the client RMI module to an edge network as an EJB edge subcomponent, and moving the server RMI module to an enterprise network as an EJB enterprise subcomponent. Alternatively, for the EJB split type, application splitter module (138) is also capable of splitting the application (130 in FIG. 1) into a client web services module and a server web services module, moving the client web services module to an edge network as an EJB edge subcomponent, and moving the server web services module to an enterprise network as an EJB enterprise subcomponent.

A façade split type implements a façade class which is an object that provides a simplified interface to a larger body of code, such as a class library. For the façade split type, for example, application splitter module (138) is capable of splitting the application (130) into a client web services module and a server web services module, moving the client web services module to an edge network as a façade edge subcomponent, and moving the server web services module to an enterprise network as a façade enterprise subcomponent.

A silo split type separates one or more entire functional components of an application forming a subcomponent of the entire functional component of the application. For the silo split type, for example, the application splitter module (138) of FIG. 2 is capable of aggregating as one subcomponent all the classes in the calling hierarchy into a silo subcomponent and moving the silo subcomponent to an edge network.

Also stored in RAM (168) is an operating system (154). Operating systems useful in computers according to embodiments of the present invention include UNIX™, Linux™, Microsoft Windows XP™, AIX™, IBM's i5/OS™, and others as will occur to those of skill in the art. Operating system (154), network management system (405), analysis modules (136), and application splitter (138) in the example of FIG. 2 are shown in RAM (168), but many components of such software typically are stored in non-volatile memory (166) also.

Computer (129) of FIG. 2 includes non-volatile computer memory (166) coupled through a system bus (160) to processor (156) and to other components of the computer. Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (129) of FIG. 2 includes a communications adapter (167) for implementing data communications (184) with edge network (106), enterprise network (124), or other computers. Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for determining availability of a destination according to embodiments of the present invention include modems for wired dial-up communications, Ethernet (IEEE 802.3) adapters for wired network communications, and 802.11b adapters for wireless network communications.

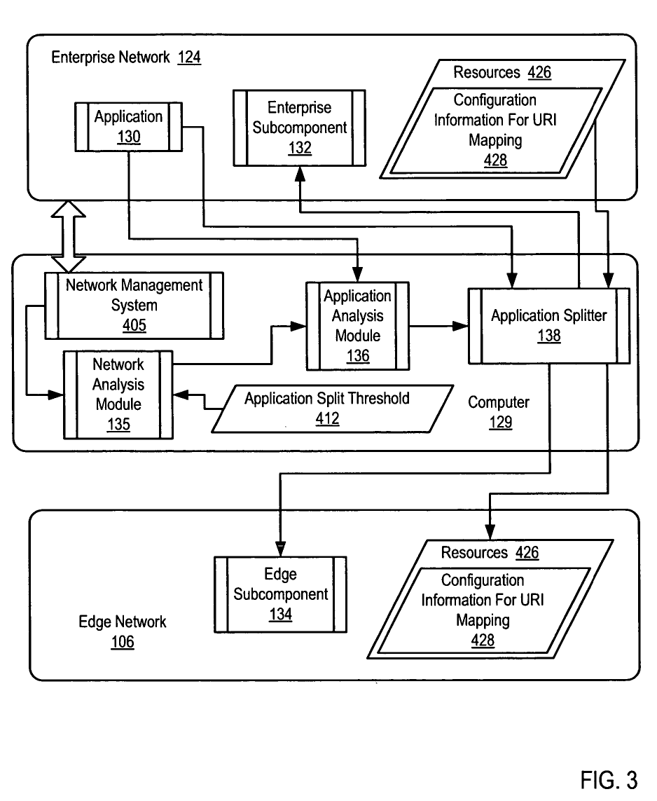

For further explanation, FIG. 3 sets forth a block diagram illustrating an exemplary system for application splitting for network edge computing according to embodiments of the present invention. The system of FIG. 3 operates generally to split an application for network edge computing according to embodiments of the present invention by gathering resource utilization data for an enterprise network (124), determining whether the resource utilization data meets an application split threshold (412), identifying an application (130) on the enterprise network (124) to split if the utilization of network resources meets the application split threshold, splitting the application (130) into a plurality of subcomponents (132, 134), and moving at least one subcomponent (134) of the application (130) to the edge network (106).

The system of FIG. 3 includes a computer (129) having a network analysis module (135), computer program instructions for gathering resource utilization data for the enterprise network (124), and determining whether the resource utilization data meets an application split threshold (412). An application split threshold is a value of resource utilization at which splitting one or more applications is predetermined to be advantageous. For example, the application spit threshold may be implemented as a value of resource utilization beyond which network performance may be degraded. More than one application split threshold may be defined for a network. For example, an application split threshold may be a function of several values each defining the utilization of a different network resource, such as bandwidth, memory, processor capacity, and so on.

When the network analysis module (135) determines that resource utilization has met or exceeded the application split threshold, the network analysis module of FIG. 3 initiates an application analysis module (136) to identify an application on the enterprise network to split. In the example of FIG. 3, the network analysis module (135) communicates with a network management system (405) to gather information about the utilization of resources on the enterprise network (124) to determine if the application split threshold (412) is met. As discussed above, one example of a network management system is the Tivol™ Enterprise Console. Although Tivol™ Enterprise Console is specifically described in this specification, this is for explanation not for limitation. In fact other network management systems exist some of which use simple network management protocol (‘SNMP’), and all such network management systems may be used for application splitting for network edge computing according to embodiments of the present invention. In the example of FIG. 3, the network management system is shown as a module installed on computer (129) which is in communication with enterprise network (124). Those skilled in the art will recognize, however, that a network management system may include a module installed on the enterprise network, a module installed on a computer (129) in communication with the enterprise network, or several modules installed on both enterprise network and a computer in communication with the enterprise network, or any other configuration that will occur to those of skill in the art.

In the example of FIG. 3, computer (129) includes an application analysis module (136), computer program instructions for identifying an application (130) on the enterprise network (124) to split. The application analysis module of FIG. 3 gathers application data of the enterprise network, and identifies an application to split based on the application data. As discussed above, application data is data describing an application and state of frequency of the current usage of the application, or the interaction of the application with enterprise network resources useful in identifying an application to split. Application data typically includes information about an application itself such as an application ID, the size of the application, the components of an application, resources used by the application, and so on as will occur to those of skill in the art. Application data also typically includes data about usage of the application such as the application's current state, resources currently consumed by the application, percentage of network traffic attributable to the application, and so on as will occur to those of skill in the art.

The application analysis module identifies an application to split based on the type of application, the usage of the application, the construction of the application, how splitting that application will affect the utilization of network resources, or other factors that will occur to those of skill in the art. For example, a currently running application may be identified to be split if the application currently uses large amounts of network resources and splitting the application will result in reducing resource utilization such that the resource utilization is below the application split threshold.

The application analysis module (136) of FIG. 3 also includes computer program instructions for gathering application data of the enterprise network (124), identifying an application split point, identifying a split type for the application split point, and determining, in dependence upon the application data, one or more preferred split types. The application analysis module (136) provides information, such as the identity of an application to be split, split points, and preferred split types, to the application splitter (138). The application splitter (138) then splits the application (130) into subcomponents, such as enterprise subcomponent (132) and edge subcomponent (134), in dependence upon information received from the application analysis module (136) and moves at least one subcomponent to the edge network.

In the example of FIG. 3, the application splitter (138) determines what resources (426) are needed on the edge network (106) for the edge network to execute the edge subcomponent (134). One example of resources (426) needed by the edge network to execute the edge subcomponent (134) includes configuration information for URI mapping (428) of DNS entries. Additional resources that may be provided to the edge network include data referenced by the edge subcomponent, as well as other resources that will occur to those of skill in the art.

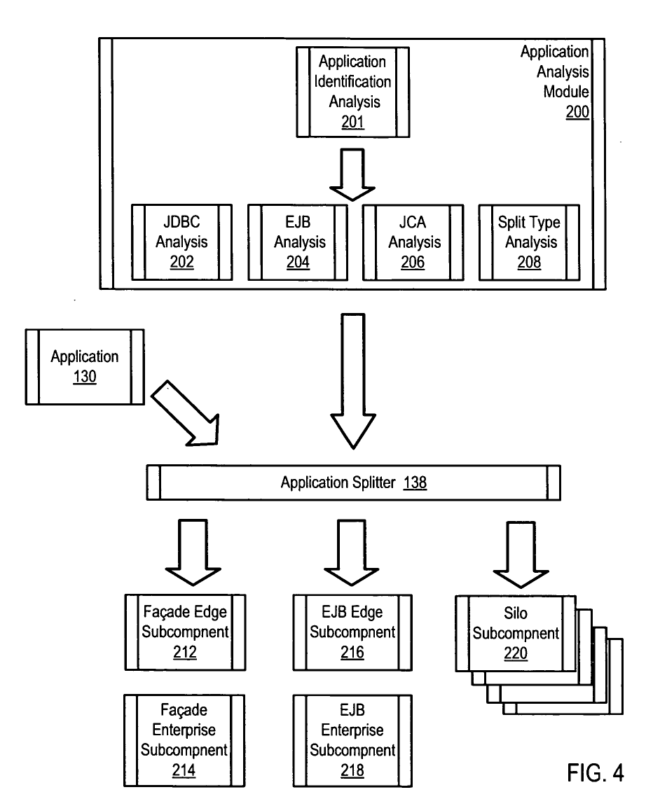

For further explanation, FIG. 4 sets forth a block diagram illustrating an exemplary system that operates generally to split an application for network edge computing according to embodiments of the present invention by identifying an application (130) on the enterprise network, and splitting the application (130) into a plurality of subcomponents. In the exemplary system of FIG. 4, the application analysis module (200) includes an application identification module (201). Application identification module (201) operates generally to identify an application (130) on the enterprise network to split. To identify an application (130) to split, the application identification module (201) gathers application data of the enterprise network, and identifies an application (130) to split based on the application data.

In the exemplary system of FIG. 4, the application analysis module (200) also includes a JDBC™ analysis module (202) that operates generally to identify application split points as classes that call Java DataBase Connectivity (“JDBC”) functions to update enterprise databases. Such calls to JDBC functions may be represented, for example, as calls to Java member methods named ‘executeUpdate’ or ‘executeInsert.’

The application analysis module (200) of the exemplary system of FIG. 4 also includes an EJB™ analysis module (204) that operates generally to identify application split points as classes that call Enterprise Java Beans (“EJBs”). Classes that call EJBs may be identified, for example, as classes that construct session EJBs using calls to the EJB Properties( ) constructor, the InitialContext( ) constructor, and so on.

The application analysis module (200) of the exemplary system of FIG. 4 also includes a JCA™ analysis module (206) that operates generally to identify application split points as classes that call Java Connector Architecture (“JCAs”) functions. Classes that call JCAs functions may be identified, for example, as classes using calls to the JCA ConnectionFactory( ), the createlnteraction( ) method, the Interaction.execute( ) method, and so on.

In the example of FIG. 4, the JDBC, EJB and JCA analysis modules (202, 204, and 206) identify split points as a list of potential split points. For each split point so identified, the split type analysis module (208) of the application analysis module (200) identifies a split type. The split type analysis module (208) operates generally to identify an EJB split type for split points that are classes that call EJB functions. The split type analysis module operates to identify a silo split type for split points that are classes that update enterprise databases through, for example JDBC calls. The split type analysis module operates to identify a silo split type for split points that are classes that make HTTP calls. The split type analysis module operates to identify a façade split type for split points that are classes identified more than once by the analytic modules (202, 204, and 206) as potential split points.

The exemplary system of FIG. 4 includes an application splitter (138), a software module that generally carries out the work of creating subcomponents of the application (130) by splitting the application at the identified split points in accordance with the preferred split type for each split point. For EJB split type, application splitter (138) may split application (130) into a client RMI™ (“Java Remote Method Invocation”) module and a server RMI module, move the client RMI module to an edge network as an EJB edge subcomponent (216), and move the server RMI module to an enterprise network as an EJB enterprise subcomponent (218). Alternatively, for the EJB split type, application splitter (138) may split application (130) into a client web services module and a server web services module, move the client web services module to an edge network as an EJB edge subcomponent (216), and move the server web services module to an enterprise network as an EJB enterprise subcomponent (218). Similarly, for the façade split type, application splitter (138) may split application (130) into a client web services module and a server web services module, move the client web services module to an edge network as a façade edge subcomponent (212), and move the server web services module to an enterprise network as a façade enterprise subcomponent (214). For the silo split type, application splitter (138) may aggregate as one subcomponent all the classes in the calling hierarchy into a silo subcomponent (220). The application splitter (138) may move the silo subcomponent (220) to an edge network or to an enterprise network.

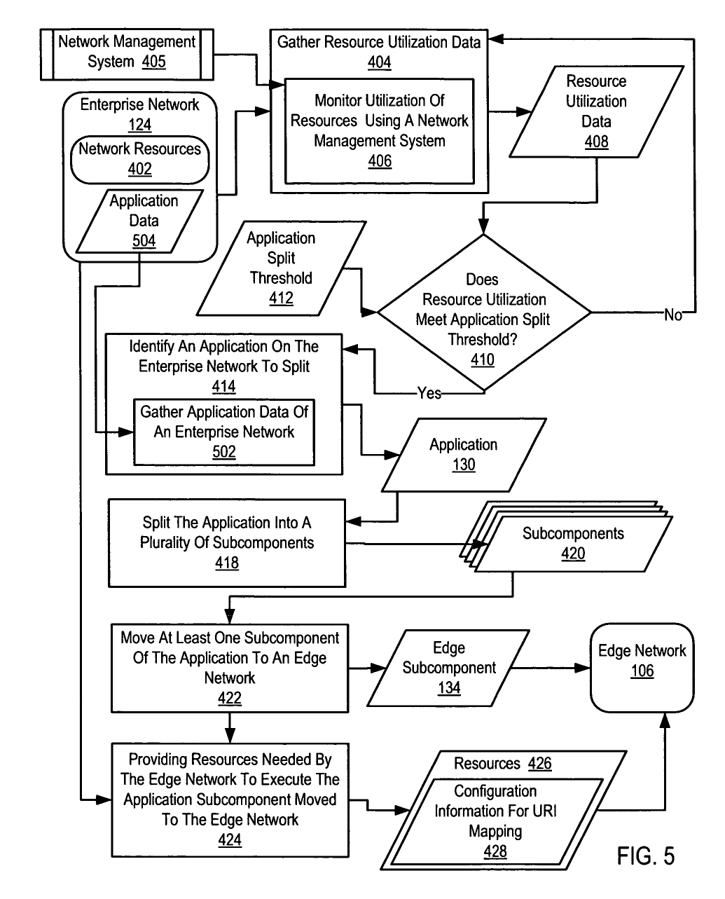

For further explanation, FIG. 5 sets forth a flowchart illustrating an exemplary method for application splitting for network edge computing according to embodiments of the present invention that includes gathering (404) resource utilization data (408) for an enterprise network (124). ‘Resource utilization data’ (408) for an enterprise network (124) is data describing the state of the consumption or availability of network resources. ‘Network resources’ refers generally to any hardware or software within a network or interconnecting network components that can be used by the network. Examples of network resources include network attached storage (or network memory), processors available to the network, routers on the network, bandwidth between nodes of the network, applications available on the network, files available on the network, and so on. Resource utilization data for an enterprise network may include data which indicates network load, network traffic information, how well the network is functioning, how well individual components of the network are functioning, how close the network is to reaching an operating capacity limit, how close an individual component of the network is to reaching an operating capacity limit, and so forth. Typical examples of resource utilization data (408) include available or consumed network bandwidth, available or consumed processing capacity, number of processes running, and types of processes running.

In the method of FIG. 5, gathering (404) network resources utilization data (408) for the enterprise network (124) is carried out by monitoring (406) utilization of network resources (402) of the enterprise network (124) using a network management system (405). Gathering resource utilization data includes both real-time monitoring, and recording and/or accessing historical resource utilization data.

The method of FIG. 5 also includes determining (410) whether the utilization of network resources (408) meets an application split threshold (412). As discussed above, an application split threshold is a value of resource utilization at which splitting one or more applications is predetermined to be advantageous. For example, the application spit threshold may be implemented as a value of resource utilization beyond which network performance may be degraded. More than one application split threshold may be defined for a network. For example, an application split threshold may be a function of several values each defining the utilization of a different network resource, such as bandwidth, memory, processor capacity, and so on.

Consider for further explanation, the following example, an application split threshold is set so that application splitting is initiated when the resource utilization is at such a level that a particular component of the network reaches a specified capacity limit, for example, 80% of available bandwidth. That is, the application split threshold for network traffic is set at 80% of available bandwidth. In this example, the current network traffic occupies 85% of available bandwidth. Comparison of the application split threshold to the resource utilization data indicates that the current network traffic exceeds the application split threshold.

The method of FIG. 5 also includes identifying (414) an application (130) on the enterprise network to split if the resource utilization data (408) meets the application split threshold (412). Identifying an application to split includes gathering (502) application data (504) of the enterprise network (124) and identifying, based on the application data, an application to split. As discussed above, application data is data describing an application and often the current usage of the application, or the interaction of the application with enterprise network resources useful in identifying an application to split.

For further explanation, consider the case when application data describing the application includes usage information about the application. The application data may include, for example, the percentage of total network traffic caused by the execution of the application. Gathering information about the usage of an application provides a vehicle for identifying applications that when split may reduce resource utilization such that the resource utilization does not exceed the application split threshold.

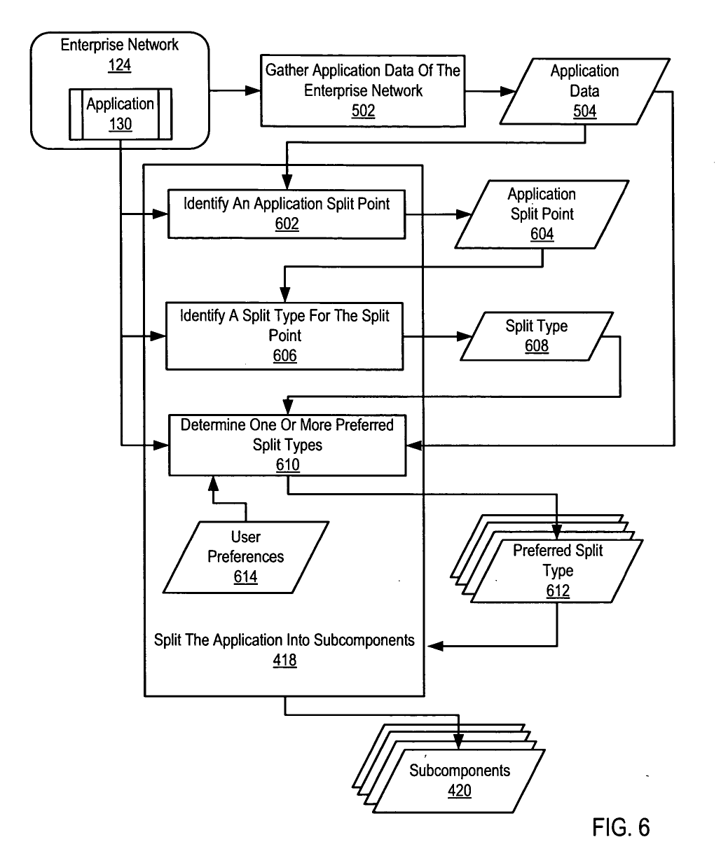

The method of FIG. 5 also includes splitting (418) the application (130) into a plurality of subcomponents (420). Splitting (418) the application (130) into a plurality of subcomponents (420) according to the method of FIG. 5 may be carried out by creating an edge subcomponent and an enterprise subcomponent. Methods of splitting the application generally include identifying split points of the application, determining split types of the split points, and splitting the application into subcomponents based on the spit points and split types. Examples of application splitting methods are discussed further below, in the descriptions of the method of FIG. 6.

The method of FIG. 5 also includes moving (422) at least one subcomponent (134) of the application (130) to an edge network (106). Moving (422) at least one subcomponent (134) of the application (130) to an edge network may be carried out by sending the subcomponent from a computer running the application splitting process, to a server of the edge network. After the subcomponent is sent to the edge network, the enterprise network typically stops executing the original application to be split, and then begins execution of the enterprise subcomponent and edge subcomponents of the split application. Application splitting for network edge computing according to the present invention may advantageously operate transparently to network users.

The method of FIG. 5 also includes providing (424), to the edge network (106), resources (426) needed by the edge network (106) to execute the edge subcomponent (134) moved to the edge network (106). Providing (424), to the edge network (106), resources (426) needed by the edge network (106) to execute the edge subcomponent (134) moved to the edge network (106) is accomplished by identifying resources (426) needed by the edge network (106) to execute the edge subcomponent (134) moved to the edge network (106) and sending the identified resources to the edge network. In the method of FIG. 5, the resources (426) needed by the edge network (106) to execute the edge subcomponent (134) moved to the edge network (106) include configuration information for URI mapping (428). Configuration information for URI mapping is however included for explanation and not for limitation. In fact, resources (426) needed by the edge network (106) to execute the edge subcomponent may include data referenced by the edge subcomponent, as well as other resources that will occur to those of skill in the art.

For further explanation, FIG. 6 sets forth a flowchart illustrating an exemplary method for application splitting for network edge computing that includes gathering (502) application data (504) of the enterprise network (124). Gathering application data according to the method of FIG. 6 is carried out by real-time monitoring of the enterprise network and accessing application data on the enterprise network.

The application data (504) may include information useful in determining a preferred split type. For example, it may be desirable to split an application with a particular split type in order to effectively free up a particular network resource for use by other applications. In an embodiment where the application data includes information useful in determining a preferred split type, the application data may include, for example, the percentage of network traffic related to the application or other information related to how network resources are used by the application.

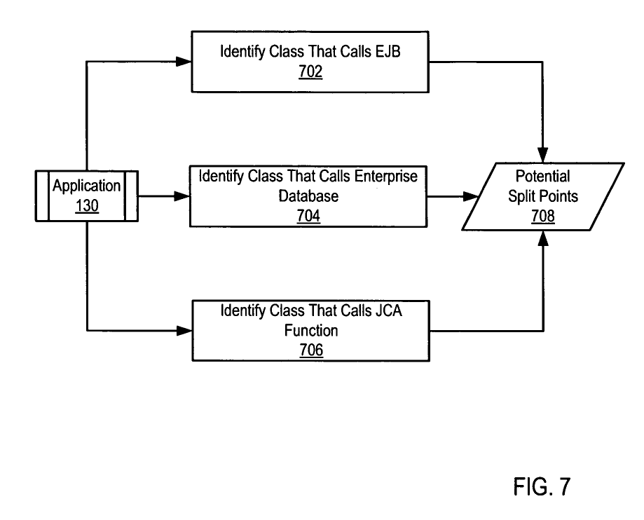

In the method of FIG. 6, splitting (418) the application into a plurality of subcomponents includes identifying (602) an application split point (604). FIG. 7 sets forth a flowchart illustrating an exemplary method for identifying an application split point. In the example of FIG. 7, identifying an application split point is carried out by identifying (702) a class of the application that calls an EJB. As noted above, a class that calls an EJB can be identified by its use of EJB member methods such as calls to the EJB Properties( ) constructor, the InitialContext( ) constructor, and so on. In the method of FIG. 7, identifying an application split point also can be carried out by identifying (704) a class of the application that updates an enterprise database through, for example, calls to JDBC methods such as ‘executeUpdate’ or ‘executeInsert.’ In the method of FIG. 7, identifying an application split point can be carried out by identifying (706) a class of the application that calls a JCA function. Classes that call JCA functions may be identified, for example, as classes using calls to the JCA ConnectionFactory( ), the createlnteraction( ) method, the Interaction.execute( ) method, and so on.

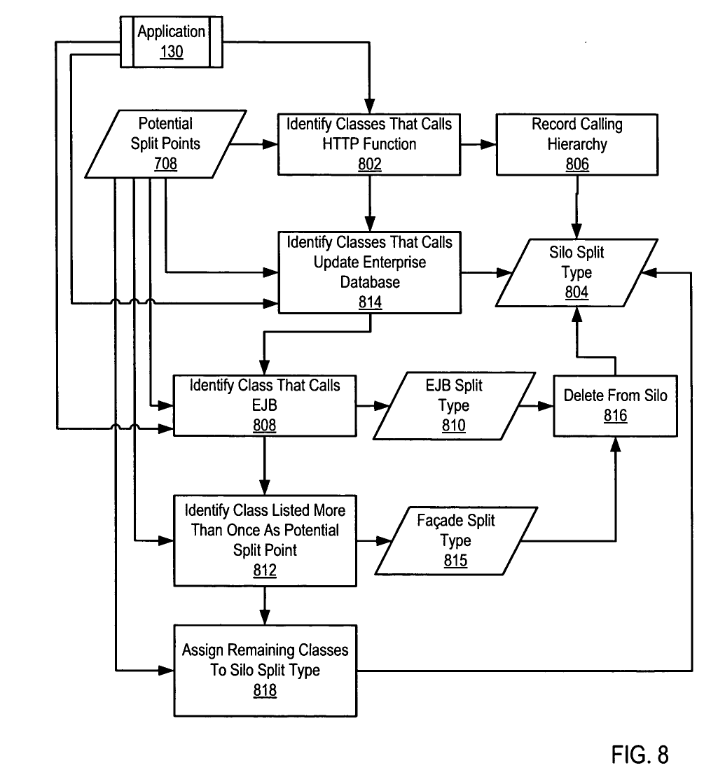

Again with reference to FIG. 6: Splitting (418) the application into a plurality of subcomponents according to the method of FIG. 6 also includes identifying (606) a split type (608) for the application split point. For further explanation, FIG. 8 sets forth a flowchart illustrating exemplary methods for identifying a split type for an application split point. In the example of FIG. 8, identifying a split type for the application split point includes identifying a silo split type (804) for the application split point. In the method of FIG. 8, identifying a silo split type (804) for the application split point can be carried out by identifying (802), from a list of potential split points (708) and the application (130), classes in the application that call an HTTP function and recording (806) the calling hierarchy of the identified class. Examples of HTTP functions include Java member methods in HTTPRequest classes, HTTPResponse classes, and HTTPSession classes.

In the method of FIG. 8, identifying a silo split type can also be carried out by identifying (814), from a list of potential split points (708) and the application (130), a class that updates an enterprise database. A class that updates an enterprise database may be identified, for example, by calls to JDBC member methods such as ‘executeUpdate’ and ‘executeInsert.’ In the method of FIG. 8, identifying a split type for the application split point includes identifying (808) an EJB split type (810) for the application split point. In the method of FIG. 8, identifying an EJB split type can be carried out by identifying (808), from a list of potential split points (708) and from the application (130) source code, a class that calls an EJB, indicated, for example, by calls to the EJB Properties( ) constructor, the InitialContext( ) constructor, and so on.

In the method of FIG. 8, identifying a split type for the application split point includes identifying a façade split type (815) for the application split point. In the method of FIG. 8, identifying a façade split type (815) for the application split point can be carried out by identifying (812), from a list of potential split points, a class that is listed more than once as a potential split point.

The method of FIG. 8 also includes assigning (818) all remaining unassigned classes on the list of potential split points to the silo split type (804). That is, in scanning through the classes listed as potential split points, and assigning the split type ‘silo’ to each split point that is not already identified as an EJB split type or a façade split type.

Some embodiments according to the present invention implement all three kinds of splits: silo splits, façade splits, and EJB splits. In such embodiments, a split point that calls HTTP functions or updates an enterprise database and also calls EJBs or is listed more than once as a potential split point may be classified as a silo split type and an EJB split type or a façade split type. That is, one split point may be assigned more than one split type. In order to avoid conflicts among the split types, such embodiments may advantageously permit only one split type per split point, implemented by deleting (816) from the silo split type (804) any split point that is also identified as an EJB split type (810) or a façade split type (815).

Again with reference to FIG. 6: Splitting (418) the application into a plurality of subcomponents according to the method of FIG. 6 also includes determining (610), in dependence upon the application data (504), one or more preferred split types (612). Preferred split types (612) may be determined in dependence upon application data (504) gathered from the enterprise network (124). Preferred split types (612) may also be determined in dependence upon specified user preferences (614). Examples of preferred split types (612) include:
no split—if entire application and its database will fit on the edge network;
split by silo split types only;
split by façade split types only;
split by EJB split types only;
split by priority: silo/façade/EJB.

The first exemplary preferred split type recites “no split—if entire application and its database will fit on the edge network.” In such an example, if the entire application and its database will fit on the edge network, the application is not split and the entire application is moved to the edge network. Determining a preferred split type therefore also includes determining, based on application data (504), whether the application (130) considered with the data it administers is too large to fit on the edge network. One way of determining whether the application considered with the data it administers is too large to fit on the edge network is carried out by comparing the available data storage capacity of edge network and the data storage requirement for the application and the data in the databases administered by the application.

In the preferred split types listed above, “split by priority: silo/façade/EJB,” means that if more than one split type is present, the application (130) is split in dependence upon priority of present split types. In this example, silo split types are preferred to façade split types and façade split types are preferred to EJB split types. That is, if all split types are present, the preferred split type is silo only. If only façade and EJB split types are present, the preferred split type is façade only. If only EJB split types are present, the preferred split type is EJB.

The method of FIG. 6 also includes splitting (418) the application into subcomponents (420) in accordance with the one or more preferred split types (612). For EJB preferred split type, the method of FIG. 6 includes splitting the application (130) into a client RMI™(“Java Remote Method Invocation”) module and a server RMI module, and moving the client RMI module to an edge network as an edge subcomponent, and moving the server RMI module to an enterprise network as an enterprise subcomponent. Alternatively for the EJB preferred split type, the method of FIG. 6 includes splitting the application (130) into a client web services module and a server web services module, moving the client web services module to an edge network as an edge subcomponent, and moving the server web services module to an enterprise network as an enterprise subcomponent. Similarly, for the façade preferred split type, the method of FIG. 6 includes splitting the application (130) into a client web services module and a server web services module, moving the client web services module to an edge network as an edge subcomponent, and moving the server web services module to an enterprise network as an enterprise subcomponent. For the silo preferred split type, the method of FIG. 6 includes aggregating as one subcomponent all the classes in the calling hierarchy into a silo module and moving the silo module to an edge network as an edge subcomponent or to an enterprise network as an enterprise subcomponent.

In addition, splitting (418) the application into subcomponents (420) in accordance with the preferred split type also may advantageously include glue insertion. That is, a subcomponent to be moved to an edge network may include data to be maintained statefully across multiple request/response exchanges. Such stateful data may be maintained in a Java HTTPSession object, for example. When application functionality is split between the edge network and the enterprise network, the stateful data may usefully be maintained on both the edge network and the enterprise network. The software used to communicate the stateful data from an edge subcomponent to a corresponding enterprise subcomponent is referred to as ‘glue.’ In typical embodiments of the present invention, gathering (502) application data (504) also includes checking for the presence of classes that maintain such stateful data, such as classes containing HTTPSession objects or references to HTTPSession objects, for example, and providing (424) resources (426) needed by the edge network to execute the application subcomponent moved to the edge network includes providing one or more glue classes and calls to glue classes to assure that the stateful data is made available as needed in both the edge module and its related enterprise modules.

Splitting (418) the application (130) into subcomponents (420) in accordance with the one or more preferred split types (612) also advantageously includes a check (not shown) that each class to be included a subcomponent is serializable. Most Java classes are serializable—unless, for example, a member method takes a native data type, such as a character or integer, for example, among its call parameters. Checking that each class in a subcomponent is serializable, therefore, may be carried out by scanning the application source code of references to native data types, reporting the discovery of such native data types, and converting them to Java classes and references to Java objects.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer-implemented method for application splitting for network edge computing, the method comprising:
gathering resource utilization data for an enterprise network;
determining whether the resource utilization data meets an application split threshold;
identifying an application on the enterprise network to split if the resource utilization data meets an application split threshold;
splitting the application into a plurality of subcomponents; and
moving at least one subcomponent of the application to an edge network.

2. The method of claim 1 wherein gathering resource utilization data for an enterprise network further comprises monitoring utilization of network resources of the enterprise network using a network management system.

3. The method of claim 1 wherein identifying an application on the enterprise network to split further comprises:
gathering application data of the enterprise network; and
identifying, based on the application data, an application to split.

4. The method of claim 1 wherein splitting the application into a plurality of subcomponents further comprises:
identifying an application split point;
identifying a split type for the application split point; and
splitting the application into subcomponents in accordance with the split type.

5. The method of claim 1 wherein splitting the application into a plurality of subcomponents further comprises:
gathering application data of the enterprise network;
identifying an application split point;
identifying a split type for the application split point;
determining, in dependence upon the application data, one or more preferred split types; and
splitting the application into subcomponents in accordance with the one or more preferred split types.

6. The method of claim 1 further comprising providing, to the edge network, resources needed by the edge network to execute the application subcomponent moved to the edge network.

7. The method of claim 6 wherein the resources needed by the edge network to execute the application subcomponent moved to the edge network comprise configuration information for URI mapping.

8. An apparatus for application splitting for network edge computing, the apparatus comprising at least one computer processor, at least one computer memory operatively coupled to the computer processor, and computer program instructions disposed within the computer memory capable of:
gathering resource utilization data for an enterprise network;
determining whether the resource utilization data meets an application split threshold;
identifying an application on the enterprise network to split if the resource utilization data meets an application split threshold;
splitting the application into a plurality of subcomponents; and
moving at least one subcomponent of the application to an edge network.

9. The apparatus of claim 8 wherein gathering resource utilization data for an enterprise network comprises monitoring utilization of network resources of the enterprise network using a network management system.

10. The apparatus of claim 8 wherein identifying an application on the enterprise network to split comprises:
gathering application data of the enterprise network; and
identifying, based on the application data, an application to split.

11. The apparatus of claim 8 wherein splitting the application into a plurality of subcomponents comprises:
identifying an application split point;
identifying a split type for the application split point; and
splitting the application into subcomponents in accordance with the split type.

12. The apparatus of claim 8 wherein splitting the application into a plurality of subcomponents comprises:
gathering application data of the enterprise network;
identifying an application split point;
identifying a split type for the application split point;
determining, in dependence upon the application data, one or more preferred split types; and
splitting the application into subcomponents in accordance with the one or more preferred split types.

13. The apparatus of claim 8 further comprising computer program instructions capable of providing, to the edge network, resources needed by the edge network to execute the application subcomponent moved to the edge network.

14. A computer program product for application splitting for network edge computing, the computer program product disposed upon a signal bearing medium, the computer program product comprising computer program instruction for:
gathering resource utilization data for an enterprise network;
determining whether the resource utilization data meets an application split threshold;
identifying an application on the enterprise network to split if the resource utilization data meets an application split threshold;
splitting the application into a plurality of subcomponents; and
moving at least one subcomponent of the application to an edge network.

15. The computer program product of claim 14 wherein the signal bearing medium comprises a recordable medium.

16. The computer program product of claim 14 wherein the signal bearing medium comprises a transmission medium.

17. The computer program product of claim 14 wherein gathering resource utilization data for an enterprise network comprises monitoring utilization of network resources of the enterprise network using a network management system.

18. The computer program product of claim 14 wherein identifying an application on the enterprise network to split comprises:
gathering application data of the enterprise network; and
identifying, based on the application data, an application to split.

19. The computer program product of claim 14 wherein splitting the application into a plurality of subcomponents comprises:
identifying an application split point;
identifying a split type for the application split point; and
splitting the application into subcomponents in accordance with the split type.

20. The computer program product of claim 14 wherein splitting the application into a plurality of subcomponents comprises:
gathering application data of the enterprise network;
identifying an application split point;
identifying a split type for the application split point;
determining, in dependence upon the application data, one or more preferred split types; and
splitting the application into subcomponents in accordance with the one or more preferred split types.
